(19) United States
(12) Patent Application Publication
(10) Pub. No.: US 2016/0178808 A1
(43) Pub. Date: Jun. 23, 2016

(54) SOL GEL LIQUID PROVIDING PROTECTION AGAINST SOLAR RADIATION GLASS COATING

(71) Applicant: KBT KIMYA SANAYI VE TICARET LTD. STI., Istanbul (TR)

(72) Inventor: Isik TOLGAY, Istanbul (TR)

(21) Appl. No.: 14/573,575

(22) Filed: Dec. 17, 2014

(51) Int. Cl. G02B 1/14; G02B 5/20

(52) U.S. Cl. CPC G02B 1/14; G02B 5/208

(57) ABSTRACT

This invention is about the sol gel liquid glass coating that is used in all glass surfaces like homes, hospitals, hotels, vehicles, restaurants, show windows and business centers and that provides protection against solar radiation; and its feature is that it represents a mixture of the organic and inorganic chemistry through the sol-gel technology.

This invention is about the sol gel liquid glass coating that is used in all glass surfaces like homes, hospitals, hotels, vehicles, restaurants, show windows and business centers and that provides protection against solar radiation.

The existing technology uses glass films that include UV absorbent and IR blocking agents for protection against the effects of solar radiation. Furthermore, there are also double glass systems that use IR absorbent agents in their internal compartments.

In applications for large areas, junctures are apparent due to the limited dimensions of glass films. Difficulties arise during applications made on sloppy windows. After application, glass films lead to problems such as peeling, formation of air bubbles and loss of gloss. In addition, windows films are easily scratched and damaged as they are not above 6H.

In solar controlled glass systems, the agents used in interim glass surfaces lose their edge over time. Using these glass systems also require changing the current frame system and therefore introduce additional costs for the users. The dimensions of said glasses are limited and they cannot be used in large glass windows.

As the product covered by the invention is liquid and spread spontaneously, it enables the formation of an integral structure on the glasses of every shape and dimension. As it is not glued to the surface using an adhesive, problems like air bubbles, peeling, swelling and loss of gloss do not appear over time. The hardness scale at 6H provides a firmer structure compared to glass films. It can be applied on existing glasses without the need for changing the glass system.

Sol (Solution) represents a colloidal suspension of thin particles that form a “gel” after undergoing hydrolysis and condensation polymerization in a liquid environment. This situation occurs at the activation stage.

Gel is defined as a cross-linked system, the form of which can vary from thin and loose to hard and tight, that is solid, that does not flow when the jelly materials are in stable condition and that is diluted to a large extend. When a gel is applied and dried as a coating, it forms a layer that is similar to hard glass.

The sol gel technology is the mixture of organic and inorganic chemistry. The coatings manufactured with the latest sol gel technology are defined as materials similar to glass or ceramic.

The most appropriate basic materials for the preparation of organic-inorganic hybrid sol-gel films are the organoalcoxysilanes. These represent silicon compounds modified by binding organic molecules to their structures and their general formulae can be shown as R′n Si(OR)4-n. Here, R′ represents an organic group and it can be functional or non-functional. When R′ is a non-functional group, it is an alkyl group like methyl, ethyl and propyl. In this case, it functions a modifier of the organic group web. The R′ group is bound to the Si atom with the Si—C link and is not hydrolyzed. If the R′ group also includes functional groups like vinyl, methacryl, epoxy, glycydioxy and amino, these then function as web makers. Such basic materials are usually defined as organofunctional alcoxysilanes and generally shown as F—(CH2)n—Si(OR)3. With the use of these basic materials known as ormosils (organically modified silanes), an inorganic web is created and also, an organic web is obtained by the help of organic structures that have polymerized. The hybrid organic-inorganic silica materials are generally prepared by the hydrolysis and condensation of tetraalcoxysilanes with one or more organoalcoxysilanes. Here, the basic material called the siloxane (alcoxy silanes) assumes the function of creating the skeleton of the structure to be formed, and the organofunctional silanes both contribute to the formation of this structure and ensure that the organic functional groups in their structures participate in the web created. The organic group included in the structure of the organofunctional trialcoxy silane compound, which is a frequently used basic material during sol-gel studies, is long and therefore, this group can perform organic polymerization and form a structure with cross-links. This organofunctional trialcoxy silane represents the basic material during the preparation of the sol-gel film. On the one hand, it contributes to the formation of the inorganic web by functioning as a SiO2 source owing to its silicon content, and on the other hand, it undergoes an organic polymerization upon the opening of the epoxy loop in the organic functional group included in its structure, and a covalent linked hybrid web structure forms between the organic-inorganic phases. The organofunctional trialcoxy silane monomers are used as linking agent during the manufacturing of coatings and films. Owing to the epoxy group, it improves the adhesive quality of the film on the surface it is applied to, and the films therefore manifest a better mechanical stability. It also renders the film porous and helps in preventing the cracks/breaks in the film. In addition to their said particularities, the epoxy group can also react with the amino group of the biomolecules. It can therefore be used for enzyme seizure, and for immobilization operations by providing that the enzyme is linked to the sol-gel matrix covalently. Films with better mechanical performances can be created by using basic materials that include organic groups that cannot be hydrolyzed.

The double reaction structure of the biofunctional organosilanes, which include reactive primary aminos and hydrolysable inorganic methoxyl groups, provides the formation of links with the inorganic materials and organic polymers. For this reason, it can increase adhesiveness and regulate surfaces.

It has an important place in alkyl trialcoxysilane sol-gel systems. It is accepted as three-functional as it hydrolyses all three alcoxy groups. In addition, the methyl group included by the material provides an organic character to the product. Hydrolysis causes that the later reactions by silanol groups yield very stable siloxane groups (—Si—O—Si).

The primary semi-product (A) used in the invention is a product that occurs when organofunctional trialcoxy silane (a1), bifunctional organosilanes that include inorganic methoxyl groups (a2) and Alkyl trialcoxysilane (a3) react under nitrogen. The first mixture, which consists of organofunctional trialcoxy silane (a1) and the bifunctional organosilane (a2) that includes inorganic methoxyl groups are mixed under a nitrogen environment. The completion of the reaction phase is waited.

The second mixture, which consists of organofunctional trialcoxy silane (a1), and the bifunctional organosilane (a2) that includes inorganic methoxyl groups, and the alkyl trialcoxysilane (a3) are mixed under a nitrogen environment. The completion of the reaction phase is waited.

The first and the second mixtures are mixed under nitrogen. The completion of the reaction phase is waited and the primary semi-product is obtained.

Gamma-glycidoxypropyltrimethoxylsilane or gamma-glycidoxypropylmethyldimethoxysilane can be used for organofunctinal trialcoxy silane (a1).

Gamma-aminopropyltriethoxysilane,N-(beta-aminoethyl)-gamma-aminopropyltrimethoxysilane, N-(beta-aminoethyl)-gamma-aminopropyldimethoxysilane can be used for the bifunctional organosilane (a2) that include inorganic methoxyl groups.

In order to have hydrophilic alcoxysilane generate the silanol that has the highest reaction in the hydroxyl group under room temperature and a condensation polymerization is obtained afterwards in the first mixture, an acid catalyzer (B) is used. Here, sulfuric acid, nitric acid, organophosphorus solutions or boron trifluoride can also be used.

The IR absorption or reflecting agent (C) that is comprised of nano-dimensioned metal oxides, is used for absorbing or reflecting ultraviolet rays. Furthermore, it is mixed into the first semi-product (A) with the acid catalyzer (B) as a co-catalyzer and a more rapid curing under room temperature is obtained. Copper, silver, iron and manganese mixtures as well as zinc oxide, ITO, ATO, ITO and ATO mixture can be used as metal oxide. UV absorbing agents (D) of benzophenone or benzotriazole types can be used for absorbing for large-scale UV rays.

If colorizing the product is desired, then colorants that are resistant to weather conditions (E) can be used. As these colorants can be used directly, they can also added to the product later on as separate dispersants. Tones of yellow, blue, green, red and black can be used. Apart from this, functional pigments like fluorescent pigments can also be used.

The solvents (F) used in the invention are the alcohol based and organic polar solvents. Organic solvents may have medium or high polarities. Alcohol based solvents aim at an easy dissolution of the additives.

[[(a1+a2]+[(a1+a2+a3]]+B+C+D+(E)+F

The surface, on which said the sol gel coating that provides solar control will be applied, should preferably be glass or hard polycarbonate. The surface should be completely cleaned of dirt and oil for ensuring that the sol gel coating adheres completely to the surface. To this end, special oil solvent mixtures can also be used in addition to cleaning made by mechanical means (razor and slightly abrasive sponge). At the conclusion of the surface preparation, isopropyl alcohol is applied on the surface by the help of a lint-free cloth and the procedure for cleaning the oil from the surface is ended.

It is important that the surface of application is cleared of dust, or measures are taken against dusting. Application is performed by a melamine based special sponge, which does not absorb the product but which serves to hold the liquid on the surface and apply it on the glass surface, or a spray with a special output. Equal application of the product on the entire surface is essential. The product will reach touching dryness in 10 minutes during summer, which is 30 minutes for winter.

1- This invention is about the sol gel liquid glass coating that is used in all glass surfaces like homes, hospitals, hotels, vehicles, restaurants, show windows and business centers and that provides protection against solar radiation; and its feature is that it represents a mixture of the organic and inorganic chemistry through the sol-gel technology.

2- Claim 1 is about the sol gel liquid glass coating that provides protection against radiation, and its feature is the inclusion of organoalcoxysilanes therein, which are the most appropriate basic materials for the preparation of organic-inorganic hybrid sol-gel films.

3- Claim is about the sol gel liquid glass coating that provides protection against radiation, and its feature is the silicon compounds modified by binding organic molecules and their general formulae can be shown as R′n Si(OR)4-n.

4- Claim 1 is about the sol gel liquid glass coating that provides protection against radiation, and its feature is the inclusion of organofunctional trialcoxysilane monomers therein, which allows its use linking agent during the manufacturing of coatings and films.

5- Claim 1 is about the sol gel liquid glass coating that provides protection against radiation, and its feature is the improving the adhesive properties of film on the surfaces where they are applied, ensuring that the films manifest mechanical stability, rendering films porous, and helping to prevent the appearance of cracks/breaks in the films.

6- Claim 1 is about the sol gel liquid glass coating that provides protection against radiation, and its feature is that the primary semi-product used in the invention is generated when (A) organofunctional trialcoxysilane (a1), bifunctional organosilanes that include inorganic methoxyl groups (a2) and alkyl trialcoxysilane (a3) react under nitrogen.

7- Claim 1 is about the sol gel liquid glass coating that provides protection against radiation, and its feature is that during the first mixture, the completion of the reaction phase is waited by ensuring the mixture of the organofunctional trialcoxysilane (a1) and bifunctional organosilanes that include inorganic methoxyl groups (a2) are mixed under a nitrogen environment.

8- Claim 1 is about the sol gel liquid glass coating that provides protection against radiation, and its feature is that during the second mixture, the completion of the reaction phase is waited by ensuring the mixture of the organofunctional trialcoxysilane (a1), bifunctional organosilanes that include inorganic methoxyl groups (a2) and alkyl trialcoxysilane (a3) under nitrogen.

9- Claim 1 is about the sol gel liquid glass coating that provides protection against radiation, and its feature is the possibility to use gamma-glycidoxypropyltrimethoxylsilane or gamma-glycidoxypropylmethyldimethoxysilane for organofunctional trialcoxysilane (a1).

10- Claim 1 is about the sol gel liquid glass coating that provides protection against radiation, and its feature is the possibility to use an acid catalyzer (B) or alternatively sulfuric acid, nitric acid, organophosphorus solutions or boron trifluoride for ensuring that hydrophilic alcoxysilane generates the silanol that has the highest reaction in the hydroxyl group under room temperature and a condensation polymerization is obtained afterwards in the first mixture.

11- Claim 1 is about the sol gel liquid glass coating that provides protection against radiation, and its feature is that the IR absorption or reflecting agent (C), which has nano dimensions and which is comprised of metal oxides, absorbs and reflects ultraviolet rays and further that, a rapid curing is obtained under room temperature when its mixed in the primary semi-product (A) with an acid catalyzer (B), the latter acting as a co-catalyzer.

12- Claim 1 is about the sol gel liquid glass coating that provides protection against radiation, and its feature is that copper, silver, iron and manganese mixtures as well as zinc oxide, ITO, ATO, ITO and ATO mixture can be used as metal oxide.

13- Claim 1 is about the sol gel liquid glass coating that provides protection against radiation, and its feature is the possibility to use UV absorbing agents (D) of benzophenone or benzotriazole types for absorbing for large-scale UV rays.

14- Claim 1 is about the sol gel liquid glass coating that provides protection against radiation, and its feature is the possibility to use colorants that are resistant to weather conditions (E) if colorizing the product is desired. As these colorants can be used directly, they can also added to the product later on as separate dispersants and tones of yellow, blue, green, red and black can be used.

15- Claim 1 is about the sol gel liquid glass coating that provides protection against radiation, and its feature is the possibility to use functional pigments like fluorescent pigments.

16- Claim 1 is about the sol gel liquid glass coating that provides protection against radiation, and its feature is that the solvents (F) used in the invention are the alcohol based and organic polar solvents.

17- Claim 1 is about the sol gel liquid glass coating that provides protection against radiation, and its feature is the possibility to have organic solvents with medium or high polarities.
